(19) United States
(12) Patent Application Publication
(10) Pub. No.: US 2008/0200561 A1
(43) Pub. Date: Aug. 21, 2008

(54) Emulsifiable Granules Formulations With Boron Containing Fertilisers

(75) Inventors: Wolfgang Wirth, Bergisch Gladbach (DE); Michel Henriet, Langenfeld (DE); Hans-Peter Krause, Hofheim (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience GMBH, Frankfurt (DE)

(21) Appl. No.: 11/575,287

(22) PCT Filed: Sep. 1, 2005
(86) PCT No.: PCT/EP2005/009411

§ 371 Date: Dec. 12, 2007

(30) Foreign Application Priority Data
Sep. 14, 2004 (EP) 04021791.1

(51) Int. Cl. A01N 25/12; A01N 53/06; A01N 43/40; A01N 43/54; A01N 37/18; A01P 13/00; A01P 15/00

(52) U.S. Cl. 514/772; 504/367; 504/311; 504/253; 504/242; 504/252; 504/341

(57) ABSTRACT

The invention relates to formulations of agrochemical compounds formulated as water emulsifiable granules and combined with boron containing fertilisers in the spray tank, to a process for the production of such formulations and to their use as novel, advantageous formulations of crop protection agents.

The invention relates to formulations of agrochemical compounds formulated as water emulsifiable granules and combined with boron containing fertilisers in the spray tank, to a process for the production of such formulations and to their use as novel, advantageous formulations of crop protection agents.

It has been observed that the use of certain micronutrients may be of benefit to the plants at the different growth stages. In particular the deficiency in boron has a negative impact on the yield as well as the quality of the harvest. Micronutrients contain various ingredients, more particularly inorganic salts such as magnesium salts, copper salts, boron salts such as Na₂B₈O₁₃*4 H₂O or boron ethanolamine and are formulated and commercialised as solid and liquid products. They are used after dilution in water as soil applications before or after sowing as well as foliar applications so as to maximise the leave coverage.

The micronutrients are more and more frequently mixed with agrochemical products in the same vessel prior to application in order to save time and costs, as well as passing through the field several times, thus to prevent the destruction of the soil texture by the farm equipment.

The tank mix procedure of applying one or more agrochemical products and micronutrients mixed in the same vessel is more and more used by the farmers. So it is imperative to ensure that the agrochemical products are compatible with the micronutrients to avoid the formation and build-up of non-redispersible particles/agglomerates which may block the spray nozzles and do not deliver the agrochemical product and the micronutrients in a homogenised way.

More recently a new insecticide formulation trade named Decis® Micro (incorporating 6.25% w/w Deltamethrin a.i.) has been commercialised as so-called “Water Emulsifiable Granule”. This formulation contains a polymer which encapsulates a liquid active ingredient or a solid active ingredient solubilised in an organic solvent. The active ingredient is immediately released in water after disintegration of the granules.

Tank mix compatibility tests have demonstrated that a severe incompatibility exists when mixing Decis® Micro with boron containing fertilisers in the spray tank under the form of agglomerated particles which block the spray nozzles.

It has been found extremely surprising that new Water Emulsifiable Granule formulations after disintegration in the spray tank filled with water are compatible with boron containing fertilisers when tank mixed prior to spraying, providing the polymer used to encapsulate the organic solution of the active compound does not belong to completely or partly hydrolysed polyvinyl acetate materials which are disclosed in EP-A-498 332.

New water emulsifiable granules formulations have now been found comprising of
at least one agrochemical active compound which is solid with a melting point above 20° C. or liquid at room temperature,
a solvent or solvent mixture,
a polymer belonging to the class of polycarboxylated products,
conventional formulation auxiliaries such as wetting agents, dispersants and/or emulsifiers, penetration enhancers, antifoam agents and fillers
   combined with boron containing fertilizers in the spray tank.

Finally it has been found that the water emulsifiable granules formulations according to the invention are very highly suitable for the application of the agrochemical active compounds contained to insects, fungi, plants and/or their habitat.

Solid, agrochemical active compounds are to be understood in the present composition as meaning all substances customary for plant treatment, whose melting point is above 20° C. if not otherwise indicated. Liquid agrochemical active compounds are to be understood in the present composition as meaning all substances customary for plant treatment, which are liquid at room temperature. Fungicides, bactericides, insecticides, acaricides, nematicides, molluscicides, herbicides, plant growth regulators and repellents may preferably be mentioned.

Examples of fungicides which may be mentioned are:
2-anilino-4-methyl-6-cyclopropyl-pyrimidine; 2′,6′-dibromo-2-methyl-4′-trifluoromethoxy-4′-trifluoromethyl-1,3-thiazole-5-carboxanilide; 2,6-dichloro-N-(4-trifluoromethylbenzyl)-benzamide; (E)-2-methoximino-N-methyl-2-(2-phenoxyphenyl)-acetamide; 8-hydroxyquinoline sulphate; methyl (E)-2-{2-[6-(2-cyanophenoxy)-pyrimidin-4-yloxy]-phenyl}-3-methoxyacrylate; methyl (E)-methoximino[alpha-(o-tolyloxy)-o-tolyl]-acetate; 2-phenylphenol (OPP), aldimorph, ampropylfos, anilazine, azaconazole,
benalaxyl, benodanil, benomyl, binapacryl, biphenyl, bitertanol, blasticidin-S, bromuconazole, bupirimate, buthiobate,
calcium polysulphide, captafol, captan, carbendazim, carboxin, quinomethionate, chloroneb, chloropicrin, chlorothalonil, chlozolinate, cufraneb, cymoxanil, cyproconazole, cyprofuram, carpropamide,
dichlorophen, diclobutrazole, dichlofluanid, diclomezin, dicloran, diethofencarb, difenoconazole, dimethirimol, dimethomorph, diniconazole, dinocap, diphenylamine, dipyrithion, ditalimfos, dithianon, dodine, drazoxolon,
edifenphos, epoxyconazole, ethirimol, etridiazole,
fenarimol, fenbuconazole, fenfuram, fenitropan, fenpiclonil, fentin acetate, fentin hydroxide, ferbam, ferimzone, fluazinam, fludioxonil, fluoromide, fluquinconazole, flusilazole, flusulfamide, flutolanil, flutriafol, folpet, fosetyl-aluminium, fthalide, fuberidazole, furalaxyl, furmecyclox, fenhexamide,
guazatine,
hexachlorobenzene, hexaconazole, hymexazole,
imazalil, imibenconazole, iminoctadine, iprobenfos (IBP), iprodion, isoprothiolan, iprovalicarb,
kasugamycin, copper preparations, such as: copper hydroxide, copper naphthenate, copper oxychloride, copper sulphate, copper oxide, oxine-copper and Bordeaux mixture,
mancopper, mancozeb, maneb, mepanipyrim, mepronil, metalaxyl, metconazole, methasulfocarb, methfuroxam, metiram, metsulfovax, myclobutanil,
nickel dimethyldithiocarbamate, nitrothal-isopropyl, nuarimol,
ofurace, oxadixyl, oxamocarb, oxycarboxine,
pefurazoate, penconazole, pencycuron, phosdiphen, pimaricin, piperalin, polyoxine, probenazole, prochloraz, procymidon, propamocarb, propiconazole, propineb, pyrazophos, pyrifenox, pyrimethanil, pyroquilon,
quintozene (PCNB), quinoxyfen,
sulphur and sulphur preparations,
tebuconazole, tecloftalam, tecnazene, tetraconazole, thiabendazole, thicyofen, thiophanate-methyl, thiram, tolclophos-methyl, tolylfluanid, triadimefon, triadimenol, triazoxide, trichlamide, tricyclazole, tridemorph, triflumizole, triforin, triticonazole, trifloxystrobin,
validamycin A, vinclozolin,
zineb, ziram and

2-[2-(1-chloro-cyclopropyl)-3-(2-chlorophenyl)-2-hydroxypropyl]-2,4-dihydro-[1,2,4]-triazole-3-thione.

Examples of bactericides which may be mentioned are:
bronopol, dichlorophen, nitrapyrin, nickel dimethyldithiocarbamate, kasugamycin, octhilinon, furancarboxylic acid, oxytetracycline, probenazole, streptomycin, tecloftalam, copper sulphate and other copper preparations.

Examples of insecticides, acaricides and nematicides which may be mentioned are:
abamectin, acephate, acrinathrin, alanycarb, aldicarb, alphamethrin, amitraz, avermectin, AZ 60541, azadirachtin, azinphos A, azinphos M, azocyclotin,
Bacillus thuringiensis, 4-bromo-2-(4-chlorphenyl)-1-(ethoxymethyl)-5-(trifluoromethyl)-1H-pyrrole-3-carbonitrile, bendiocarb, benfuracarb, bensultap, betacyfluthrin, bifenthrin, BPMC, brofenprox, bromophos A, bufencarb, buprofezin, butocarboxine, butylpyridaben,
cadusafos, carbaryl, carbofuran, carbophenothion, carbosulfan, cartap, chloethocarb, chloretoxyfos, chlorfenvinphos, chlorfluazuron, chlormephos, N-[(6-chloro-3-pyridinyl)-methyl]-N′-cyano-N-methyl-ethaneimidamide, chlorpyrifos, chlorpyrifos M, cis-resmethrin, clocythrin, clofentezin, clothianidin, cyanophos, cycloprothrin, cyfluthrin, β-cyfluthrin, cyhalothrin, cyhexatin, cypermethrin, cyromazin,
deltamethrin, demeton-M, demeton-S, demeton-S-methyl, diafenthiuron, diazinon, dichlofenthion, dichlorvos, dicliphos, dicrotophos, diethion, diflubenzuron, dimethoate,
dimethylvinphos, dioxathion, disulfoton,
emamectin, esfen valerate, ethiofencarb, ethion, ethofenprox, ethoprophos, etrimphos,
fenamiphos, fenazaquin, fenbutatin oxide, fenitrothion, fenobucarb, fenothiocarb, fenoxycarb, fenpropathrin, fenpyrad, fenpyroximate, fenthion, fenvalerate, fipronil, fluazuron, flucycloxuron, flucythrinate, flufenoxuron, flufenprox, fluvalinate, fonophos, formothion, fosthiazate, fubfenprox, furathiocarb,
HCH, heptenophos, hexaflumuron, hexythiazox,
imidacloprid, iprobenfos, isazophos, isofenphos, isoprocarb, isoxathion, ivermectin, lambda-cyhalothrin, lufenuron,
malathion, mecarbam, mevinphos, mesulfenphos, metaldehyde, methacrifos, methamidophos, methidathion, methiocarb, methomyl, metolcarb, milbemectin, monocrotophos, moxidectin,
naled, NC 184, nitenpyram,
omethoate, oxamyl, oxydemethon M, oxydeprofos,
parathion A, parathion M, permethrin, phenthoate, phorate, phosalon, phosmet, phosphamidon, phoxim, pirimicarb, pirimiphos M, pirimiphos A, profenophos, promecarb, propaphos, propoxur, prothiophos, prothoate, pymetrozine, pyrachlophos, pyridaphenthion, pyresmethrin, pyrethrum, pyridaben, pyrimidifen, pyriproxifen,
quinalphos,
salithion, sebufos, silafluofen, sulfotep, sulprofos,
tebufenozide, tebufenpyrad, tebupirimiphos, teflubenzuron, tefluthrin, temephos, terbam, terbufos, tetrachlorvinphos, thiacloprid, thiafenox, thiamethoxam, thiodicarb, thiofanox, thiomethon, thionazine, thuringiensin, tralomethrin, transfluthrin, triarathen, triazophos, triazuron, trichlorfon, triflumuron, trimethacarb,
vamidothion, XMC, xylylcarb, zetamethrin.

Examples of molluscicides which may be mentioned are metaldehyde and methiocarb.

Examples of herbicides which may be mentioned are:
anilides, such as, for example, diflufenican and propanil; arylcarboxylic acids, such as, for example, dichlorpicolinic acid, dicamba and picloram; aryloxyalkanoic acids, such as, for example, 2,4-D, 2,4-DB, 2,4-DP, fluroxypyr, MCPA, MCPP and triclopyr; aryloxy-phenoxy-alkanoic acid esters, such as, for example, diclofop-methyl, fenoxaprop-ethyl, fluazifop-butyl, haloxyfop-methyl and quizalofop-ethyl; azinones, such as, for example, chloridazon and norflurazon; carbamates, such as, for example, chlorpropham, desmedipham, phenmedipham and propham; chloroacetanilides, such as, for example, alachlor, acetochlor, butachlor, metazachlor, metolachlor, pretilachlor and propachlor; dinitroanilines, such as, for example, oryzalin, pendimethalin and trifluralin; diphenyl ethers, such as, for example, acifluorfen, bifenox, fluoroglycofen, fomesafen, halosafen, lactofen and oxyfluorfen; ureas, such as, for example, chlortoluron, diuron, fluometuron, isoproturon, linuron and methabenzthiazuron; hydroxylamines, such as, for example, alloxydim, clethodim, cycloxydim, sethoxydim and tralkoxydim; imidazolinones, such as, for example, imazethapyr, imazamethabenz, imazapyr and imazaquin; nitriles, such as, for example, bromoxynil, dichlobenil and ioxynil; oxyacetamides, such as, for example, mefenacet; sulphonylureas, such as, for example, amidosulfuron, bensulfuron-methyl, chlorimuron-ethyl, chlorsulfuron, cinosulfuron, metsulfuron-methyl, nicosulfliron, primisulfuron, pyrazosulfuron-ethyl, thifensulfuron-methyl, triasulfuron and tribenuron-methyl; thiocarbamates, such as, for example, butylate, cycloate, diallate, EPTC, esprocarb, molinate, prosulfocarb, thiobencarb and triallate; triazines, such as, for example, atrazine, cyanazine, simazine, simetryne, terbutryne and terbutylazine; triazinones, such as, for example, hexazinon, metamitron and metribuzin; others, such as, for example, aminotriazole, benfuresate, bentazone, cinmethylin, clomazone, clopyralid, difenzoquat, dithiopyr, ethofumesate, fluorochloridone, glufosinate, glyphosate, isoxaben, pyridate, quinchlorac, quinmerac, sulphosate and tridiphane. In addition, 4-amino-N-(1,1-dimethylethyl)-4,5-dihydro-3-(1-methylethyl)-5-oxo-1H-1,2,4-triazole-1-carboxamide and 2-((((4,5-dihdydro-4-methyl-5-oxo-3-propoxy-1H-1,2,4-triazol-1-yl)carbonyl)amino)-sulfonyl) methyl benzoate may be mentioned.

Examples of plant growth regulators which may be mentioned are chlorocholine chloride and ethephon.

Examples of repellents which may be mentioned are diethyl-tolylamide, ethylhexanediol and butopyronoxyl.

Formulations with deltamethrin as active ingredient are very preferably mentioned.

Formulations with cyfluthrin as active ingredient are also very preferably mentioned.

Formulations with β-cyfluthrin as active ingredient are also very preferably mentioned.

Formulations with imidacloprid as active ingredient are also very preferably mentioned.

Formulations with thiacloprid as active ingredient are also very preferably mentioned.

Formulations with clothianidin as active ingredient are also very preferably mentioned.

Formulations with pirimicarb as active ingredient are also very preferably mentioned.

The polymer which has been found suitable to encapsulate the organic solution of the active compound in the present formulation belongs to the class of polycarboxylated products, more particular the copolymer formed by the polymerisation of maleic anhydride with an ethylenic derivative (2,4,4-trimethylpentene or diisobutylene), average molecular weight of 4000-8000, available as a sodium salt as disclosed in WO 00/26 280. The trade name is Geropon EGPM.

Suitable solvents or solvent mixtures are aromatic hydrocarbons such as 1-methylnaphtalene, tetrahydronaphtalene, decahydronaphtalene, 2-methylnaphtalene, dimethylnaphtalene, alkylbenzene derivatives, xylene (including Solvesso 200®, Solvesso 200® ND), mixtures of dibenzyltoluene isomers (such as Marlotherm S®) and mixtures of benzyltoluene isomers (such as Marlotherm L®), phosphate esters such as tri-n-butylphosphate, aliphatic hydrocarbons such as mineral or vegetable oils, alcohols such as cyclohexanol, C8 alcohol derivatives, ethers such as dibenzylether, ketones such as cyclohexanone, 4-methylcyclohexanone, amides such as N,N-dimethylcaprylamide-capramide (Hallcomid M8-10), esters such as alkylbenzoates, phtalates such as monoalkyl- or dialkylphtalate, pyrrolidones such as N-methylpyrrolidone, N-octylpyrrolidone (AgsolEx 8®), N-dodecylpyrrolidones (AgsolEx 12®), N-cyclohexylpyrrolidone.

Suitable wetting agents are ionic or non ionic surfactants or a mixture of these surfactants, such as alkyl sulfate salts (for example: sodium lauryl sulfate (Sipon LCS 98®), alkyl ether sulfate salts (for example: sodium lauryl ether sulfate)), alkylaryl sulfonate salts (such as polycarboxylic acid salts), ethylene oxide condensates on fatty alcohols or fatty acids or fatty amines, substituted phenols such as nonylphenols or octylphenols or polyarylphenols, sulfosuccinic acid ester salts, α-olefin sulfonate salts, taurin derivatives such as alkyltaurates (for example: oleyl methyltaurate).

Suitable dispersing agents are ionic or non ionic surfactants or a mixture of these surfactants, such as phenol sulfonic or alkylnaphtalene sulfonic acid salts of various alkyl chain lengths; condensation products of arylsulfonic acids or sodium salts with formaldehyde such as condensation products of alkylnaphtalene sulfonic acid or sodium salt with formaldehyde (for example: Morwet D425, Supragil MNS 90, Tamol NN8906, Galoryl DT505); the sodium salt of a sulfonic acid made from m-cresol, formaldehyde and sodium sulfite (for example: Dispersogen 1494); the sodium salt of a sulfonic acid made from cresol, formaldehyde, sodium sulfite and oxynaphtalenesulfonic acid; lignosulfonates (for example: sodium lignosulfonate and calcium lignosulfonate); polyphenyl sulfonates, polyacrylic acid salts; lignosulfonic acid salts (for example: Kraft polymerised lignosulfonic acid, sodium salt); triethanolamine and potassium salts of phosphorylated or sulfated polystyrylphenylpolyethlene oxides, calcium dodecylbenzene sulfonate.

Suitable emulsifiers which can optionally be added are nonionic, anionic and cationic surfactants, and mixtures of nonionic with anionic components are preferably used. However, combinations of nonionic and cationic surfactants can also be used. The emulsifiers which are preferably used include calcium phenylsulfonate, ethoxylated arylphenols such as ethoxylated nonylphenols and ethoxylated octylphenols, ethoxylated aliphatic alcohols, ethoxylated castor oil, fatty acid esters such as sorbitan laurate and sorbitan oleate such as Alkamuls S 80, fatty acid polyglycol esters such as ethoxylated sorbitan laurate and ethoxylated sorbitan oleate, propylene glycol/ethylene glycol block polymers and mixtures of these, phosphorylated ethylene glycol/propylene glycol/ethylene glycol block polymers.

Suitable penetration enhancers are ethoxylated fatty alcohols such as Genapol C 100 (WO 02/098230), alkoxylated alcohols such as 2-ethyl hexyl alkoxylate (WO 03/000053), ethoxylated tridecyl alcohols such as Lutensol TO 6 (WO 03/059066).

Suitable antifoam agents/defoaming agents are based on silicone, particularly preferred are an aqueous emulsion of dialkylpolysiloxanes commercially available as Rhodorsil® 426R from Rhodia Chimie France, Wacker SE serie from Wacker, Germany and a mixture of dialkylpolysiloxanes as an oil, commercially available as Rhodorsil® 416 from Rhodia Chimie France, Wacker S184 or Wacker SL from Wacker, Germany.

Suitable fillers are a precipitated colloidal silica (for example Wessalon S) or a calcinated silica, a clay such as kaolinite clay (for example: Argirec B24).

Typical boron containing fertilisers on the market are Solubor (a powdered fertilizer containing 20.8% spray dried borate sodium, Na₂B₈O₁₃*4 H₂O); Boramine (borone ethanolamine, a liquid fertilizer containing 10.2% boron); Gikabore (a liquid fertilizer containing 150 g/l Boramine).

The content of the individual components can be varied within a wide range in the formulations according to the invention. Thus, the concentrations
of agrochemical active compounds are in general between 1 and 70% by weight, preferably between 5 and 40% by weight,
of solvent or solvent mixture are in general between 0 and 80% by weight, preferably between 15 and 60% by weight,
of polymer are in general between 10 and 80% by weight, preferably between 30 and 60% by weight,
of emulsifiers are in general between 0.5 and 40% by weight, preferably between 1 and 25% by weight,
of conventional formulation auxiliaries selected from the group comprising the fillers, penetrants, agents are in general between 0 and 20% by weight, preferably between 5 and 15% by weight.

The content of boron containing fertiliser can be varied within a wide range with the water emulsifiable granule formulations used in tank mixture upon spray application according to the invention. Thus, the concentrations expressed as boron material are in general between 2 and 50% by weight, preferably between 5 and 25% by weight.

The application rate of the formulation according to the invention can be varied within a relatively wide range. It depends on the particular agrochemical active compounds and their content in the formulations.

The water emulsifiable granules according to the invention can be prepared stepwise as follows:
1. Preparation of an oil-in-water slurry by:
   preparing independently an organic phase-A—comprising the technical active ingredient which is solubilised in a solvent or solvent mixture or used as such if it is used as a liquid technical material,
   preparing independently an aqueous phase-B—comprising the polymer solution further diluted with water and whose the pH has been adjusted to 5.0-6.5, preferably to 5.3-5.9 by addition of aqueous hydrochloric acid under efficient stirring, during a period of time long enough to prevent formation of lumps;
   dispersing the organic phase-A—into the aqueous phase-B—under stirring using a high-speed stirrer such as an Ystral Dispermix Y/DD50005 EXD/LDT-3. The addition can be performed batchwise or continuously if suitable equipments are used.

The viscosity raises during the mixing of both phases. Further addition of water leads to a sharp decrease in viscosity so to handle the resulting slurry in an easier manner in the subsequent step.

The temperature can be kept constant during the emulsification procedure, but can also varied after certain periods of time. It should be in the range from 10 to 80° C., preferably 25 to 50° C.

The droplets formed in this process have a diameter d50 of 0.5 to 20 μm, preferably 1.0 to 10 μm, depending on the speed of stirring or dispersing.
2. Granulation of the slurry:

The resulting viscous slurry is continuously fed to a fluidized bed drier such as an Aeromatic MP-1 or a Glatt GPCG5 by the countercurrent principle, thus removing the water from the product in stream of warm air. To avoid potential problems such as stringiness, film formation on the walls of the drying unit, clogging of the inlet opening and formation of larger agglomerates, the viscosity of the slurry should be between 50 and 5000 cps, preferably between 100 and 1000 cps, depending on the metering conditions and drying temperatures selected. The gas inlet temperature ranges between 110 and 150° C., preferably between 120 and 140° C. and the gas outlet temperature ranges between 40 and 70° C., preferably between 50 and 60° C. Evaporation of water ranges from 25 to 50%, preferably from 35 to 45% while the quantity of solvent (i.e. aromatic hydrocarbon) loss ranges from 25 to 70%, preferably from 40 to 55%.

The above mentioned drying process allows water to be removed from the granules down to a residual moisture of less than 0.5% by weight.

The resulting granules have an average particle size of o0.3 to 5 mm, preferably 0.5 to 2 mm, are free-flowing, do not evolve dust, can readily be metered volumetrically, and form a stable emulsion in water.

The properties of the formulated granules according to the invention are essentially unchanged after 3 months storage at room temperature and up to 50° C.

The invention is illustrated by the following example:

### PREPARATION EXAMPLE

### Example

A solution of 4.22 kg of Deltamethrin technical is solubilised in a vessel containing 17.02 kg of Solvesso 200 (containing 25% in excess to compensate the loss of solvent in the subsequent drying step) and 11.9 kg of Tri-n-butylphosphate under stirring, followed by the addition of 0.69 kg of Alkamuls S80.

66.75 kg of Geropon EGPM (25% solid polymer solubilised in water) are introduced in a second vessel, followed by the addition of 18.69 kg of a 7.3% hydrochloric acid solution under vigorous stirring, over a period of time long enough to prevent the formation of polymer lumps.

The organic solution is the added to the aqueous phase under powerful stirring. A further addition of 13.28 kg of water completes the preparation of the slurry. The speed of the stirrer is then decreased and stirring continued for an additional 10 minutes. The droplets which are formed in the aqueous phase reach an average mean diameter of 0.5 to 5 μm.

The slurry is then fed to a fluidized bed drier. The resulting water-emulsifiable granules have a mean particle diameter of 0.5 to 2 mm, do not evolve dust, are free-flowing, can readily be metered volumetrically and can be emulsified readily in water.

### Use Examples

### Cylinder Test (see Table 1)

400 ml tap water (10° C.) are added into a 500 ml cylinder. The boron containing fertilizer is added according to the recommended dose rate and the cylinder is inverted in order to homogenize the mixture. Then the active compound formulation is added according to the recommended dose rate. The cylinder is left for a few minutes and the visual observations are recorded (observations after 5 minutes). Then the cylinder is inverted for max 30 times and the visual observations are recorded (observations after 20 minutes).

| Deltamethrin Formulations | | Boron containing fertilizers | | | | Observation |
|---|---|---|---|---|---|---|
| | Product dose rate | | Product dose rate | Observation upon addition of | Observation after | after |
| Formulations | per 150 l water | Product | per 150 l water | Deltamethrin formulation | 5 minutes | 20 minutes |
| Deltamethrin | 120 g | None | | Disintegration of the granules | Emulsion formed. | As after 5 |
| formulated according to | | | | and emulsification process start. | Homogeneous spray | minutes |
| the invention | | | | | solution. | |
| Decis ® Micro | 120 g | None | | Very slow disintegration of the | Granules still present. | Some granules |
| | | | | granules. Emulsification process | | still not fully |
| | | | | very slow. | | disintegrated. |
| Deltamethrin | 120 g | Boramine | 4 litres | Disintegration of the granules | Emulsion formed. | As after 5 |
| formulated according to | | | | and emulsification process start. | Homogeneous spray | minutes |
| the invention | | | | | solution. | |
| Decis ® Micro | 120 g | Boramine | 4 litres | Very slow disintegration of the | Granules still present. | Some granules |
| | | | | granules. Emulsification process | Chewing gum like | still not fully |
| | | | | very slow. Chewing gum like | material in suspension | disintegrated. |
| | | | | material in suspension. | | Chewing gum |
| | | | | | | like material in |
| | | | | | | suspension. |
| Deltamethrin | 120 g | Solubor | 5 kg | Disintegration of the granules | Emulsion formed. | As after 5 |
| formulated according to | | | | and emulsification process starts. | Homogeneous spray | minutes. |
| the invention | | | | | solution. | |
| Decis ® Micro | 120 g | Solubor | 5 kg | Very slow disintegration of the | Granules still present. | Some granules |
| | | | | granules. Emulsification process | Chewing gum like | still not fully |
| | | | | very slow. Chewing gum like | material in | disintegrated. |
| | | | | material in suspension. | suspension. | Chewing gum |
| | | | | | | like material in |
| | | | | | | suspension. |
| Deltamethrin | 120 g | Gikabore | 4 litres | Disintegration of the granules | Emulsion formed. | As after 5 |
| formulated according to | | | | and emulsification process starts | Homogeneous spray | minutes |
| the invention | | | | | solution. | |

1. A water emulsifiable granule formulation, comprising of
at least one agrochemical active compound which is a solid with a melting point above 20° C. or a liquid at room temperature,
a solvent or solvent mixture,
a polymer belonging to the class of polycarboxylated products, and
optionally one or more formulation auxiliaries,
combined with a boron containing fertilizer in a spray tank.

2. A water emulsifiable granule formulation according to claim 1, wherein the agrochemical active compound is deltamethrin, cyfluthrin, β-cyfluthrin, imidacloprid, thiacloprid, clothianidin or pirimicarb.

3. (canceled)

4. A water emulsifiable granule formulation according to claim 1, comprising
between 1 and 70% by weight of at least one agrochemical active compound which is a solid with a melting point above 20° C. or a liquid at room temperature,
between 0 and 80% by weight of a solvent or solvent mixture,
between 10 and 80% by weight of a polymer belonging to the class of polycarboxylated products,
between 0.5 and 40% by weight of an emulsifiers emulsifier, and
between 0 and 20% by weight of formulation auxiliaries,
combined with between 2 and 50% by weight of a boron containing fertilizers fertilizer.

5. A method for controlling animal pests, comprising contacting animal pests with a formulation according to claim 1.

6. A method for controlling animal pests comprising, contacting animal pests and/or their habitat with a formulation according to claim 1.

7. A process for preparing a water emulsifiable granule formulation according to claim 1, comprising,
preparing an oil-in-water emulsion by dispersing under high shear an organic phase A into an aqueous phase B containing a polymer solution,
wherein said organic phase A is obtained by dissolving an agrochemical active compound in a solvent or a solvent mixture and adding formulation auxiliaries, or if said agrochemical active compound is a liquid, providing said agrochemical active compound in the absence of a solvent or a solvent mixture,
drying said oil-in-water emulsion to obtain said water emulsifiable granule, and
adding said water emulsifiable granule to a boron containing fertilizer in a spray tank.
